(19) United States
(12) Patent Application Publication
(10) Pub. No.: US 2002/0076578 A1
(43) Pub. Date: Jun. 20, 2002

(54) Magnetic recording medium

(76) Inventors: Yasushi Hattori, Kanagawa (JP); Nobuyoshi Asada, Kanagawa (JP)

Correspondence Address: STROOCK & STROOCK & LAVAN LLP, 180 Maiden Lane, New York, NY, 10038, US

(21) Appl. No.: 10/005,430

(22) Filed: Nov. 2, 2001

(30) Foreign Application Priority Data
Nov. 2, 2000 (JP) P.2000-336246

(51) Int. Cl. G11B 5/738

(52) U.S. Cl. 428/694 BS

(57) ABSTRACT

A magnetic recording medium comprises a support and coated layers, wherein the coated layers comprises: a lower layer containing a non-magnetic powder dispersed in a binder; and a magnetic layer containing a ferromagnetic powder dispersed in a binder, in the order, and the coated layers has a whole pore volume of 10 to 50 mm³/g.

### BACKGROUND OF THE INVENTION

1. Field of the Invention

The present invention relates to a magnetic recording medium for recording and reproducing, particularly, digital signals at a high density.

2. Description of the Related Art

Magnetic recording media have been widely used as sound recording tapes, video tapes, computer tapes, disks, etc. The recording density of magnetic recording media becomes yearly higher, the recording wavelengths have become shorter, and the recording system has been investigated from an analog system to a digital system.

For the requirement of increasing the recording density, the magnetic recording medium of a so-called particulate medium type for by dispersing a ferromagnetic powder in a binder and coating the dispersion on a support was inferior in the electromagnetic characteristics to a metal thin film type magnetic recording medium because of the low packing degree of the ferromagnetic powder, but by the recent progress of the ferromagnetic powder and progress of a vary thin-layer coating technique, the electromagnetic characteristics of the former has been almost same as those of the latter. Furthermore, the former type magnetic recording medium is excellent in the points of the productivity, the corrosion resistance, etc.

As the particulate type magnetic recording medium, a magnetic recording medium prepared by coating a magnetic layer containing a ferromagnetic powder such as ferromagnetic iron oxide, Co-modified ferromagnetic iron oxide, CrO₂, a ferromagnetic metal (including alloy), etc., in a binder on a support has been widely used.

For improving the electromagnetic characteristics, there are the improvement of the magnetic characteristics of a ferromagnetic powder, smoothening of the surface of the magnetic layer, etc., and various method are proposed but a method of sufficient for the increase of the recording density has not yet been proposed. Also, recently, there is a tendency of shortening the recording wavelength together with the increase of the recording density, when the thickness of the magnetic layer is thick, the problems of the self-demagnetization loss at recording by lowering the output and the thickness loss at reproducing become large, and a particulate type magnetic recording medium of a very thin layer has been proposed.

Also, recently, in a magnetic tape cassette used for Hi-8 and digital VCR (SD standard) for public use (hereinafter, the tape cassette is referred to as DVC), a so-called ME (metal evaporated tape), that is, a magnetic recording tape vapor deposited with a metal thin film has been practically used, and a system of using both a so-called MP (metal particulated) tape, that is a particulate type magnetic recording tape and the ME tape has been practically used.

For being used together with the ME tape, it is necessary that in the MP tape, the magnetic layer is thinned to increase the output as in the ME tape, the relation of the recording electric current and the output is established to be same as that of the ME tape. Hitherto, when in the MP tape, the recording electric current is increased, the reproducing output is lowered by the recording demagnetization, but in the ME tape, such a tendency does not occur and when the recording electric current is increased, the reproducing output tends to be saturated. Accordingly, actually, in the Hi-8 deck, a system of recording both the Mp tape and the ME tape by different recording electric currents, respectively to cause a fault that the circuit is complicated. For solving the fault, it is necessary to record both the tapes by a same recording electric current as the system capable to be used together by the MP tape and the ME tape, but there is a problem that when the MP tape is recorded and reproduced by the optimum recording electric current of the ME tape, the output is lowered. On the contrary, when the ME tape is recorded and reproduced by the optimum electric current of the MP tape, the ME tape cannot give the real power and the output is lowered. Thus, it has been demanded to make the optimum electric current of the MP tape almost same as that of the ME tape.

Also, in the digital VCR for public use, the signal of the recording wavelength of 22 μm has been employed as the synchronous signal and as the data, the signal of the recording wavelength of 0.488 μm has been employed. Also, for light weighting, an overwrite erasion omitting an erasing head has been employed. For employing the overwrite erasion, it is necessary to erase the synchronous signal by the data signal, and it is said to be desirable that the overwrite-erasing ratio is −20 dB or lower. As the necessary character for the magnetic recording medium, it is desired to lower the overwrite-erasing ratio as low as possible.

It has been considered that for lowering the overwrite-erasing ratio, the coercive force Hc of the magnetic layer may be lowered.

However, by lowering the coercive force Hc, the overwrite performance can be improved but there is a limit since the high frequency output is lowered by the recording demagnetization. Also, it is shown to thin the thickness of the magnetic layer, but there is a limit in the means since when the thickness is too thin, the magnetized amount becomes deficient and regardless of a short wavelength and a long wavelength, the whole output becomes small.

As the means of insuring the magnetized amount in a very thin magnetic layer, there are a method of using a ferromagnetic powder having a high saturation magnetization σs and a method of reducing the content of a binder resin and non-magnetic powders such as abrasives. However, in these cases, there are problems that the output is lowered by lowering the dispersibility of a magnetic liquid to roughen the surface property of the magnetic layer, and the running durability is greatly lowered by the insufficiency of the strength of the magnetic layer.

### SUMMARY OF THE INVENTION

The present invention is to provide a magnetic recording medium having good electromagnetic characteristics and particularly, an object of the invention is to provide a magnetic recording medium having a high output and being excellent in the overwrite characteristics as a magnetic recording tape used for digital recording.

The object of the invention is attained by a magnetic recording medium having formed on a support coated layers having a lower layer containing a non-magnetic powder dispersed in a binder and a magnetic layer containing a ferromagnetic powder dispersed in a binder in the order, characterized in that the whole pore volumes of the coated layers are from 10 to 50 mm³/g.

The preferred embodiments of the invention are as follows.

(1) The magnetic recording medium wherein the residual magnetic flux density Br of the magnetic layer is at least 500 mT.

(2) The magnetic recording medium wherein the coercive force Hc of the magnetic layer is from 2100 to 3000 Oe (≅ from 168 to 240 kA/m) the SFD of the magnetic layer is 0.30 or lower, and the average thickness d of the magnetic layer is d≦recording wavelength λ/4.

(3) The magnetic recording medium wherein the magnetic layer and the lower layer are formed by simultaneous double layer coating.

### DETAILED DESCRIPTION OF THE INVENTION

In the invention, the whole pore volumes of the coated layers mean the sum total of the volumes of pores existing in the region from the surface of the coated layer to the inside thereof per gram of the coated layers.

In the invention, the above-described whole pore volumes are pore volumes obtained by an N₂ adsorption method using an all automatic gas absorbed amount measuring apparatus “AUTOSORB-1” manufactured by QUANTA CHROME CORPORATION.

In the invention, the whole pore volumes of the coated layers are controlled to from 10 to 50 mm³/g, and preferably from 10 to 35 mm³/g, and by the construction, the magnetic recording medium having the good electromagnetic characteristics, and particularly the magnetic tape having a high output and being excellent is the overwrite characteristics can be provided.

In the magnetic recording medium of the invention, there is no particular restriction on the layer construction, if the coated layers having a lower layer and a magnetic layer (hereinafter, the lower layer is sometimes called a non-magnetic layer and the magnetic layer is sometimes called an upper layer) are formed on a support in the order. For example, as the magnetic layer, two or more layers each having a different ferromagnetic metal powder composition may be laminated. In this case, as the average thickness of the magnetic layers of the invention, it is preferred that the total sum of the layers is not thicker than (λ/4). Since λ means an optional recording wavelength, the minimum value of the average thickness inevitably becomes (1/4) or lower of the shortest recording wavelength. As the value of the d is smaller, the overwrite characteristics become better but the output tends to lower. Accordingly, the d of the magnetic layer is preferably from 0.02 to 0.4 μm, more preferably from 0.02 to 0.2 μm, and far more preferably from 0.02 to 0.1 μm. Also, the average thickness of the lower layer is, for example, in the range of from 0.5 to 3 μm, and preferably from 0.8 to 3 μm.

Also, in the invention, the residual magnetic flux density Br of the magnetic layer(s) is preferably at least 500 mT, and more preferably in the range of from 500 to 800 mT. By establishing the Br to the above-described value, lowering of the 1/90 Tb output can be prevented.

As the means of controlling the whole pore volumes as described above and obtaining the above-described magnetic layer characteristics, it is illustrated to increase the packing degree of a ferromagnetic powder, particularly a ferromagnetic metal powder contained in the magnetic layer, and, for example, there are following means.

(a). A binder resin having an excellent dispersibility is used and also the amount thereof is reduced.

(b). The surfaces of the ferromagnetic powders are modified to improve the dispersibility thereof.

(c). The migration of a binder resin (particularly, low-molecular components) from the lower layer into the magnetic layer is retrained.

(d). The lower layer is hardened, whereby the lower layer is hard to be formed by a calender.

Also, as the ferromagnetic powder contained in the magnetic layer, by employing the ferromagnetic metal powder having the Hc of from 2200 to 3000 Oe, the saturation magnetization as of from 140 to 170 A·m²/kg, the crystallite size of from 100 to 170 angstroms, and the SFD of 1.0 or lower, the ranges of the Hc, the SFD, and the d of the magnetic layer can be suitably controlled, whereby the MP tape having the electromagnetic characteristics as those of an ME tape can be prepared. In this case, more preferred ranges of the Hc is from 2250 to 2800 Oe, the as is from 150 to 170 A·m²/kg, the crystallite size is from 120 to 160 angstroms, and the SFD is 0.95 or lower and more preferably 0.85 or lower.

In the magnetic recording medium of the invention, since the HC of the magnetic layer can be highly established, the 1/2 Tb output (high-frequency output) is insured, and since even when the d is thinned as 0.12 μm or lower, the Br can be increased and also the low SFD can be insured, lowering of the 1/90 Tb output (tracking signal output) can be restrained and also the good O/W (overwrite) can be insured.

The practical methods of the above-described (a), (b), (c), and (d) are explained. First, the method of (a) is described below.

As the method (a), there are a method of using as the binder resins contained in the magnetic layer, a polyurethane resin is used in an amount of preferably from 50 to 100% by weight, and more preferably from 70 to 100% by weight of the total binder resins and a method of using the total binder resins in an amount of preferably from 5 to 18% by weight, and more preferably from 5 to 12% by weight to the ferromagnetic powder of the magnetic layer.

It is preferred that the above-described polyurethane resin is made of a polyurethane resin, which is the reaction product of a diol and an organic diisocyanate as the main raw materials, and the diol components contain a short-chain diol unit having a cyclic structure and a long-chain diol unit having an ether group. Also, the polyurethane resin is preferably a binder containing from 17 to 40% by weight the short-chain diol unit having the cyclic structure in the polyurethane resin and containing from 10 to 50% by weight the long-chain diol unit in the polyurethane resin, said long-chain diol unit containing from 1.0 to 5.0 mmol/g of an ether group to the total polyurethane resin.

The short-chain diol having the cyclic structure means a diol having a saturated or unsaturated cyclic structure and having a molecular weight of less than 500. For example, diols having an aromatic or an aliphatic, such as bisphenol A, hydrogenated bisphenol A shown by the formula 1 described below, bisphenol S, bisphenol P; and the ethylene oxide or propylene oxide addition products of them; cyclohexane dimethanol, cyclohexane diol, etc., are preferred.

Formula 1

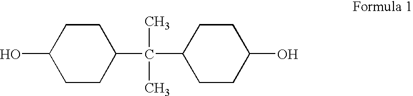

More preferably, there are hydrogenated bisphenol A shown by the formula 1 and the ethylene oxide or propylene oxide addition product of it.

Also, the short-chain diol having the cyclic structure is usually selected from the diols having molecular weights of from 50 to less than 500. Also, together with above-described the short-chain diol having the cyclic structure, usually other diol having a molecular weight of less than 500 can be used. As such other diols, there are, practically, straight-chain or branched diols such as ethylene glycol, 1,3-propylenediol, 1,2-propylene glycol, 1,4-butanediol, 1,5-pentanediol, 1,6-hexanediol, 2,2-dimethylpropanediol, 1,8-octanediol, the ethylene oxide or propylene oxide addition product of N-diethanolamine, etc.

By using these diols, coated films having a high strength and a high Tg by the cyclic structures and also having a high durability are obtained. Furthermore, by the introduction of branched CH₃, the solubility in a solvent is excellent, whereby a high dispersibility is obtained.

The content of the short-chain diol unit in the polyurethane resin is preferably from 17 to 40% by weight, and more preferably from 20 to 30% by weight.

Also, the long-chain diol means a diol having a molecular weight of at least 500, and practically, the addition product of bisphenol A, hydrogenated bisphenol A, bisphenol S, or bisphenol P with ethylene oxide and/or propylene oxide; polypropylene oxide, polyethylene glycol, and polytetramethylene glycol are preferred, and the compounds shown by following Formula 2 are particularly preferred.

Formula 2

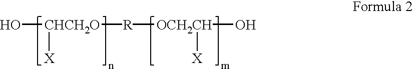

wherein R is at least one of:

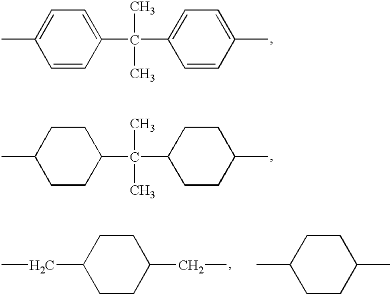

Also, in the above-described formula 2, the values of n and m are desirably from 3 to 24. Also, in the long-chain diol, R is preferably following (1) or (2).

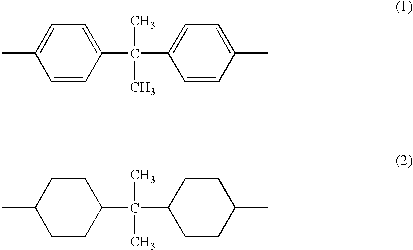

R of (1) is more preferred. Also, in the long-chain diols shown by the formula 2, X is preferably a hydrogen atom or a methyl group, and is more preferably a methyl group. In addition, all Xs in the bracket bound by n or m are not necessary same but they show hydrogen atom(s) and methyl group(s).

The polyurethane resin used in the particularly preferred embodiment in the invention has a high coated film strength and an excellent durability because of having a cyclic structure and also is enriched in the solubility in solvent and excellent in the dispersibility because of having branched CH₃ of propylene.

The weight average molecular weight (Mw) of the long-chain diol is usually from 500 to 5000, and preferably is selected from the range of from 700 to 3000. The content of the long-chain diol unit containing an ether group is preferably from 10 to 50% by weight, and more preferably from 30 to 40% by weight in the polyurethane resin. Also, the content of the ether group of the long-chain diol unit is preferably from 1.0 to 5.0 mmol/g, and more preferably from 2.0 to 4.0 mmol/g in the polyurethane resin.

The number average molecular weight (Mn) of the polyurethane resin in the invention is preferably from 18000 to 56000, and more preferably from 23000 to 34000. Also, the weight average molecular weight (Mw) of the polyurethane resin is preferably from 30,000 to 100,000, and more preferably from 40,000 to 60,000.

The glass transition temperature Tg of the polyurethane resin used in the invention is usually in the range of from 0 to 200° C., preferably from 30 to 150° C., and more preferably from 30 to 130° C.

The above-described polyurethane resin may be used together with other synthetic resin such as a vinyl chloride-base resin, and the like. The polymerization degree of the vinyl chloride-base resin, which can be used together with the polyurethane resin is preferably from 200 to 600, and particularly preferably from 250 to 450. The vinyl chloride-base resin may be the resin obtained by copolymerizing vinyl chloride with other vinyl-base monomer such as vinyl acetate, vinyl alcohol, vinylidene chloride, acrylonitrile, etc. Also, the vinyl chloride-base resin may be used together with a cellulose derivative such as a nitrocellulose resin, etc.; an acrylic resin, a polyvinyl acetal resin, a polyvinyl butyral resin, an epoxy resin, a phenoxy resin, etc., and they can be used singly or as a combination of them.

In addition, it is preferred that the above-described polyurethane resin is compounded in all the coated layers.

Then, the method (b) described above is explained. For the purpose, there is a method of incorporating an aromatic organic acid compound modifying the surface of the ferromagnetic powder in the magnetic layer, and the content of the organic compound is established to be preferably from 0.1 to 0.8 mol, and more preferably from 0.2 to 0.5 mol to 1 kg of the ferromagnetic powder.

It is preferable that the aromatic organic acid compound has a property of strongly adhering to various powders including at least a ferromagnetic powder and has a high affinity with the polyurethane resin. Accordingly, as the aromatic organic acid compound, the organic acid compound having a dissociation constant of as large as possible (strong acid) is preferred, and an organic acid having a pKa value of not larger than 3 and the salts thereof are suitable.

The aromatic organic acid compound is a conception of including free acids, the salts and the derivatives thereof, such as, for example, the esters thereof, etc. Also, the above-described adsorption to powders is a conception of including a physical adsorption and also a chemical adsorption including a covalent bond.

The organic acid having the pKa value of not larger than 3 includes α-naphthylphosphoric acid, phenylphosphoric acid, diphenylphosphoric acid, p-ethylbenzenephosphonic acid, phenylphosphonic acid, phenylphosphinic acid, methanesulfonic acid, benzenesulfonic acid, p-toluenesulfonic acid, naphthalene-α-sulfonic acid, naphthalene-β-sulfonic acid, etc., and the salts of these acids.

There is no particular restriction on the using method of the aromatic organic acid compound if the using method is the embodiment capable of obtaining the above-described characteristics, but there are preferably a method of simultaneous adding the aromatic organic acid compound at kneading the ferromagnetic powder and the binder in the preparation of the coating material and a method of previously surface treating the ferromagnetic powder with the aromatic organic acid compound before kneading the aromatic organic acid compound with the bonder. When the lower layer is formed, it is preferred to incorporate the aromatic organic acid compound in the lower layer, and in this case, the aromatic organic acid compound is used in the range of usually from 0.1 to 0.5 mol, and preferably from 0.1 to 0.35 mol to 1 kg of the non-magnetic powder.

Then, the above-described method (c) is explained.

By reducing the amount of the binder resin in the lower layer, the content of the low-molecular components can be reduced and at simultaneous double layer coating, the migration of the low-molecular components from the lower layer into the upper layer can be reduced. For the purpose, there is a means that the amount of the binder resin (including a hardening agent) of the lower layer is established to be preferably from 14 to 25 parts by weight, and more preferably from 14 to 20 parts by weight to 100 parts by weight of the total amounts of the non-magnetic inorganic powders.

In this case, as the low-molecular components, there are the low-molecular components contained in the resins such as the polyurethane resin, the vinyl chloride-base resin, etc., and also the unreacted components of a polyisocyanate compound used in the case of hardening the binder. Also, the non-magnetic inorganic powder includes an inorganic powder, carbon black, an abrasive, and the like.

Also, when as the binder resin of the lower layer, a low-molecular vinyl chloride-base resin, preferably, a vinyl chloride-base resin having a number average molecular weight by a gel permeation chromatography (GPC) of from about 5000 to 15,000 is used, for the magnetic layer, for example, the polyurethane resin only made of the above-described short-chain diol and long-chain diol is used as the binder resin, or a binder resin mainly made of the above-described polyurethane resin is used, and the lower layer and the upper layer are formed by a simultaneous double layer coating method, a small amount of the vinyl chloride-base resin can be deposited near the surface of the magnetic layer. Thereby, there are the effects that the glass transition point Tg of the surface layer portion of the magnetic layer is properly lowered and the calender processing property can be more improved. In this case, it is preferred that the polyurethane resin made of the above-described short-chain diol is also used for the lower layer together with the above-described binder resin for the lower layer, and the polyurethane resin is used in the range of usually from 10 to 80% by weight, and preferably from 15 to 60% by weight to the whole binder resins (including the hardening agent).

However, in regard to the migration, since the contribution of the components of the molecular weight of less than 5000 by the measurement of the number average molecular weight by GPC is large, in the case of using the vinyl chloride-base resin for the magnetic layer, it is more effective to restrain the occurrence of the migration by reducing the using amount of the vinyl chloride-base resin of the lower layer. From such a view point, the content of the above-described polyurethane resin is in the range of from 20% by weight to 100% by weight, and more preferably from 20 to 80% by weight to the whole binder resins of the lower layer.

Also, by reducing the amount of the binder resin of the lower layer as the case of the above-described method (c), the hardness of the lower layer to the magnetic layer can be relatively lowered. Accordingly, in the invention, by thinning the average thickness of the magnetic layer, the magnetic layer can be liable to be influenced by the hardness of the lower layer, whereby the head-touching can be improved. Also, when the binder resin mainly comprised of the polyurethane resin made of the above-described short-chin diol and long-chain diol is used for the magnetic layer, the tenacity of the magnetic layer is insured, and it is better to use a binder resin composition imparted with the plasticity, for example, a resin composition obtained by curing the above-described polyurethane resin and the vinyl chloride-base resin having, if necessary, a polar group (for example, a sulfo group and the group of the potassium salt thereof) with a polyisocyanate compound for the non-magnetic layer.

On the other hand, as the above-described method (d), by that the lower layer is hardened and the lower layer is hard to be formed at the calender treatment, the force of the calender is used for the deformation of the magnetic layer, whereby the whole pore volumes of the coated layers can be controlled to the range of the invention and also the packing degree of the magnetic layer can be increased. As such a method, it can be given as the preferred correspondences to reduce the particle size of the non-magnetic powder contained in the lower layer and to increase the Tg of the binder used for the lower layer as described below. Also, it is effective that after calender treating the lower layer, the magnetic layer is coated on the lower layer and then the magnetic layer is subjected to a calender treatment.

In the invention, the standard deviation σ of the thickness of the magnetic layer is preferably not larger than 0.05 μm, and as the means of attaining the σ, in addition to the above-described means, a known one can be applied. For example, it is preferred that the magnetic layer is formed on the lower layer by a simultaneous double layer coating method and in this case, there are illustrated a method that the coating materials of both layers having the approximating viscoelasticities are used (for example, in particular, the kinds and the sizes of the powders of the coating material of the lower layer are selected to control the thixisotropic property), a method that the sizes of the powders contained in both the layers are controlled such that there is no mixed region in the interface between the lower layer and the upper layer (for example, as the non-magnetic inorganic powder of the lower layer, an inorganic powder, the mean particle size of which is from ½ to 4 times the crystalline size of the acicular ferromagnetic metal powder of the upper layer or is not larger than ⅓ of the long axis length of the acicular ferromagnetic metal powder, is employed), and the method described in Japanese Patent No. 2566096, etc.

The average thickness d of the magnetic layer and the standard deviation σ of the magnetic layer mean the values measured by the following methods. The magnetic medium is cut along the lengthwise direction by a diamond cutter at a thickness of about 0.1 μm, the cut sample is observed by a transmission type electron microscope at from 10,000 to 100,000 magnifications, and preferably from 20,000 to 50,000 magnifications, and the photograph is taken. The print size of the photograph is A4 to A5. Thereafter, by observing the shape differences of the ferromagnetic powder of the magnetic layer and the non-magnetic inorganic powder of the lower layer, the interface is edged with black by visually deciding, and also, the surface of the magnetic layer is similarly edged with black. Thereafter, by an image processing apparatus IBAS2 manufactured by Zeiss Ikon G.m.b.H., the lengths of the edged lines are measured. When the length of the sample photograph is 21 cm, the measurement is carried out from 85 to 300 times.

The mean value of the measured values in the case is defined as d, and the standard deviation C is obtained by the following formula.

σ=[{(d₁−d)²+(d₂−d)²+ - - - +(dₙ−d)²}/(n−1)]^{½}

Wherein, d₁, d₂, - - - , dₙ each shows each measured value, and n is from 85 to 300. In addition, it is preferred that the largest value of the measured values of the thickness of the magnetic layer is in the range of from about 1.0 to 3 times of d. Also, it is preferred that the shortest value of the measured values is in the range of from about 0.4 to 1 times of d.

There is no particular restriction on the ferromagnetic powder used in the invention, but a ferromagnetic metal powder is preferred, and in these metal powders, the powders of Fe and Fe-base alloys are preferred. These ferromagnetic metal powders may contain, in addition of the definite atom(s), Al, Mg, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, etc. Particularly, the metal powder containing at least one of Al, Mg, Si, Ca, Y, Ba, La. Nd, Co, Ni, and B in addition to Fe is preferred.

These ferromagnetic metal powders may be previously treated with a dispersing agent, a lubricant, a surface active agent, an antistatic agent, etc., as described later, before dispersing in a binder resin. Practically, these ferromagnetic metal powders are described in Japanese Patent Publication Nos. 14090/1969, 18372/1971, 22062/1972, 22513/1072, 28466/1971, 38755/1971, 4286/1972, 12422/1972, 17284/1972, 18509/1972, 18573/1972, 10307/1964, and 39639/1973, U.S. Pat. Nos. 3,026,215, 3,031,341, 3,100,194, 3,242,005, and 3,389,014, etc.

The ferromagnetic metal powder may contain a small amount of a hydroxide or an oxide. The ferromagnetic metal powders used in the invention may be obtained by known production methods as described below. That is, there are a method of reducing with a composite organic acid salt (mainly, an oxalate) and a reducing gas such as hydrogen, etc., a method of obtaining Fe particles or Fe—Co particles by reducing iron oxide with a reducing gas such as hydrogen, etc., a method of thermally decomposing a metal carbonyl compound, a method of reducing a ferromagnetic metal by adding a reducing agent such as sodium borohydride, a hypophosphite, or hydrazine to an aqueous solution of the ferromagnetic metal, a method of obtaining the fine powder of a metal by evaporating the metal in an inert gas at a low pressure, etc. The ferromagnetic metal powder thus obtained is subjected to a known slow oxidation treatment, such as a method of immersing in an organic solvent followed by drying, a method of immersing in an organic solvent, introducing an oxygen-containing gas into the mixture to form an oxide film on the surface of the metal powder followed by drying, or a method of forming an oxide film on the surface of the metal powder by controlling the partial pressures of an oxygen gas and an inert gas without using an organic solvent, etc., before using the ferromagnetic metal powder.

The specific surface area (S_{BET}) by a BET method of the ferromagnetic metal powder used for the magnetic layer of the invention is preferably selected from 30 to 50 m²/g. Thereby, both the good surface property and the low noise become possible. The average long axis length of the ferromagnetic metal powder is preferably from 0.05 to 0.15 μm, and more preferably from 0.08 to 0.12 μm.

The acicular ratio {long axis length/short axis length (the largest width of the vertical direction to the long axis)} of the ferromagnetic metal powder used in the invention is preferably from 4 to 18, and more preferably from 5 to 12. The water content of the ferromagnetic metal powder is preferably from 0.01 to 2%. It is preferred that according to the kind of the binder, the optimum water content of the ferromagnetic metal powder is selected.

It is preferred that the pH of the ferromagnetic metal powder is optimized by the combination with the binder used. The range the pH is usually from 4 to 12, and preferably from 7 to 10. Also, if necessary, Al, Si, P or the oxide thereof may exist on the surface of the ferromagnetic metal powder. The amount thereof is from 0.1 to 10% by weight to the ferromagnetic metal powder and when a surface treatment is applied to the ferromagnetic metal powder having such a substance on the surface thereof, the adsorption of a lubricant such as a fatty acid, etc., preferably becomes 100 mg/m². As the case may be, the ferromagnetic metal powder contains an inorganic ion such as Na, Ca, Fe, Ni, Sr, etc., but when the content thereof is not more than 200 ppm, they do not give particular influences on the characteristics of the ferromagnetic metal powder.

Also, it is preferred that the ferromagnetic metal powder used in the invention has holes as less as possible, and the value thereof is preferably not more than 20% by volume, and more preferably not more than 5% by volume. Also, the shape of the ferromagnetic metal powder is preferably acicular but may be granular, rice-grain form, or plate form.

As the ferromagnetic metal powder contained in the magnetic layer, the saturation magnetization (σs) is from 115 to 130 A·m²/kg (and more preferably from 118 A·m²/kg to 128 A·m²/kg).

Then, the detailed content of the lower layer, which is used in a preferred embodiment of the invention, is explained.

The non-magnetic powder, which is used for the lower layer of the invention as the main ingredient, is a non-magnetic metal powder, which can be selected from, for example, inorganic compounds such as metal oxides, metal carbonates, metal sulfates, metal nitrides, metal carbides, metal sulfides, etc. As the inorganic compound, α-alumina of the α ratio of at least 90%, β-alumina, γ-alumina, θ-alumina, silicon carbide, chromium oxide, cerium oxide, α-iron oxide, goethite, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, and molybdenum disulfide are used singly or as a combination of them. The preferred inorganic compounds are titanium dioxide, zinc oxide, iron oxide, and barium sulfate, and the more preferred inorganic compounds are titanium dioxide and a iron oxide.

The mean particle size of these non-magnetic inorganic powders is preferably not larger than 0.15 μm for reducing the pore volumes of the lower layer portion and further adjusting the whole pore volumes of the coated layers, and particularly preferred mean particle size of the non-magnetic inorganic powder is from 0.01 μm to 0.1 μm.

In the specification of the application, the mean particle size is as follows. That is (1) when the shape of the powder is acicular, a spindle-shape, columnar (in this case, however, the height is larger than the largest diameter of the bottom surface), etc., the mean particle size is shown by the length of the long axis constituting the powder, that is, shown by the mean value of the long axis lengths, (2) when the shape of the powder is a plate-shape or columnar (in this case, however, the thickness or the height, that is, the thickness of the plate is smaller than the largest long diameter of the plate surface or the bottom surface), the mean particle size is shown by the mean value of the largest diameters of the plate surfaces or the bottom surfaces, that is by the average value of the plate diameters, and (3) when the shape of the powder is spherical, a polyhedron shape, an unspecified shape, etc., and from the shape, the long axis constituting the powder cannot be specified, the mean particle size is shown by the mean value of circle-corresponding diameters. The circle-corresponding diameter is the diameter obtained by a circle projection method. Also, the mean particle size of the case of mixing above-described cases (1) to (3) is the value of the sum total of each measured sizes divided by the total number of the powders.

Also, the above-described mean particle size of powders in the invention is the mean particle size obtained from a high dissolving power transmission type electron microphotographs by applying the measurement as described above to about 200 powders.

Also, in the case of (1), the mean axis ratio of the powders means the arithmetic average of the value of (long axis length/short axis length) of each powder, which is also called a mean acicular ratio, in the case of (2), the mean axis ratio means the arithmetic average of the value of (plate diameter/plate thickness) of each powder, which is also called a mean plate-shape ratio, and in the case of (3), the mean axis ratio is regarded as 1.

When the non-magnetic inorganic powder is a granular metal oxide, the mean particle size is preferably not larger than 0.03 μm, and when the non-magnetic inorganic powder is an acicular metal oxide, the mean long axis length is preferably not longer than 0.15 μm, and more preferably not longer than 0.1 μm.

A tap density o the non-magnetic inorganic powder is usually from 0.05 to 2 g/ml, and preferably from 0.2 to 1.5 g/ml. The water content of the non-magnetic inorganic powder is usually from 0.1 to 5% by weight, preferably from 0.2 to 3% by weight, and more preferably from 0.3 to 1.5% by weight. The pH of the non-magnetic inorganic powder is usually from 2 to 11 but the pH is particularly preferably from 7 to 10. The surface area of the non-magnetic inorganic powder is usually from 1 to 100 m²/g, preferably from 5 to 70 m²/g, and more preferably from 10 to 65 m²/g. The crystallite size of the non-magnetic inorganic powder is preferably from 0.004 μm to 1 μm, and more preferably from 0.04 to 0.1 μm. The oil absorption using dibutyl phthalate (DBP) is from 5 to 100 ml/100 g, preferably from 10 to 80 ml/100 g, and more preferably from 20 to 60 ml/100 g. The specific gravity is usually from 1 to 12, and preferably from 3 to 6. The shape of the non-magnetic inorganic powder may be any of acicular, spherical, a polyhedron, and a plane shape.

It is preferred that the ignition loss is not more than 20% by weight and it is most preferred that there is no such an ignition loss. The Mohs' hardness of the above-described non-magnetic inorganic powder used in the invention is preferably from 4 to 10. The roughness factor of the surface of the non-magnetic inorganic powder is preferably from 0.6 to 1.5, and more preferably from 0.9 to 1.2. The SA (stearic acid) adsorbed amount of the non-magnetic inorganic powder is preferably from 1 to 20 μmol/m², and more preferably from 2 to 15 μmol/m². Also, it is preferred that the heat of wetting of the non-magnetic inorganic powder in water at 25° C. is in the range of 200 to 600 mJ/m². Also, a solvent in the range of the heat of wetting can be used. The amount of water molecules on the surfaces of the non-magnetic inorganic powders at a temperature of from 100 to 400° C. is properly from 1 to 10 molecules/100 angstroms. The pH of the isoelectric point of the non-magnetic inorganic powder in water is preferably from 3 to 9.

It is preferred that on the surfaces of the non-magnetic inorganic powders exists Al₂O₃, SiO₂, TiO₂, ZrO₂, SnO₂, Sb₂O₃, or ZnO by applying a surface treatment. Particularly preferred oxides for the dispersibility of the non-magnetic inorganic powder are Al₂O₃, SiO₂, TiO₂, and ZrO₂, but more preferred oxides are Al₂O₃, SiO₂, and ZrO₂. They can be used as a combination of them and can be used singly. Also, according to the purpose, coprecipitated surface treated layer may be used, or a method of applying silica after applying alumina onto the surface layer or a method of applying alumina after applying silica onto the surface layer can be employed. Also, the surface treated layer may be a porous layer according to the purpose but a uniform and dense layer is generally preferred.

Practical examples of the non-magnetic inorganic powder used for the lower layer of the invention include Nanotite, manufactured by SHOWA DENKO K.K.; HIT-100 and ZA-G1, manufactured by Sumitomo Chemical Company, Limited; DPN-250, DPN-250BX, DPN-245, PPN-270BX, DPB-550BX, and DPN-550RX; manufactured by Toda Kogyo K.K.; titanium oxide, TTO-51B, TTO-55A, TTO-55B, TTO-55C, TTO-55S, TTO-55D, SN-100, and MJ-7 and α-iron oxide, E270, E271, and E 300, manufactured by ISHIHARA SANGYO KAISHA, LTD.; STT-4D, STT-30D, STT-30, and STT-65C, manufactured by Titan Kogyo K.K.; MT-100S, MT-100T, MT-150W, MT-500B, MT-600B, MY-100F, and MT-500HD, manufactured by TAYCA CORPORATION; FINEX-26, BF-1, BF-10, BF-20, and ST-M, manufactured by Sakai Chemical Industry Co., Ltd.; DEFIC-Y and DEFIC-R, manufactured by DOWA MINING CO., LTD.; AS2BM and TiO2P25, manufactured by Nippon Aerosil K.K.; 100A and 500A, manufactured by Ube Industries, Ltd.; Y-LOP, manufactured by Titan Kogyo K.K.; and the burned products pf them.

The particularly preferred non-magnetic inorganic powders are titanium dioxide and α-iron oxide. α-iron oxide (hematite) is prepared under the following various conditions.

The α-Fe₂O₃ powder uses, as the precursor particles, the acicular goethite particles obtained by (1) a method of forming acicular goethite particles by preparing a suspension containing a ferrous hydroxide colloid obtained by adding at least an equivalent amount of an aqueous solution of an alkali hydroxide to an aqueous ferrous solution and carrying out the oxidation reaction by passing an oxygen-containing gas through the suspension at a pH of at least 11 and a temperature of not higher than 60° C.; (2) a method of forming goethite particles of spindle shape by preparing a suspension containing FeCO₃ obtained by reacting an aqueous solution of a ferrous salt and an aqueous solution of an alkali carbonate and carrying out the oxidation reaction by passing an oxygen-containing gas through the suspension, (3) a method of forming acicular goethite nucleus particles by carrying out the oxidation reaction by passing an oxygen-containing gas through an aqueous ferrous salt solution containing a ferrous hydroxide colloid obtained by adding less than an equivalent amount of an aqueous alkali hydroxide solution or an aqueous alkali carbonate solution to an aqueous ferrous solution, and then after adding an aqueous alkali hydroxide solution to the aqueous ferrous salt solution containing the acicular goethite nucleus particles in an amount of at least the equivalent amount to Fe²⁺ in said aqueous ferrous salt solution, passing an oxygen-containing gas to grow the above-described acicular goethite nucleus particles, and (4) a method of forming acicular goethite nucleus particles by carrying out the oxidation reaction by passing an oxygen-containing gas through an aqueous ferrous salt solution containing a ferrous hydroxide colloid obtained by adding less than an equivalent amount of an aqueous alkali hydroxide solution or an aqueous alkali carbonate solution to an aqueous ferrous solution, and then growing the above-described goethite nucleus particles in an acid or neutral region, etc.

In addition, during the formation reaction of the goethite particles, a foreign element such as Ni, Zn, P, Si, etc., which is usually added for improving the characteristics of a particle powder, may be added to the reaction system.

By dehydrating the acicular goethite particles which are the precursor particles at a temperature range of from 200 to 500° C., or, if necessary, further annealing the acicular goethite particles by heat-treating at a temperature range of from 350 to 800° C., the particles of acicular α-Fe₂O₃ are obtained.

In addition, the acicular goethite particles, which are dehydrated or annealed, may have attached to the surfaces a sintering preventing agent which is a compound containing P, Si, Zr, Sb, etc. The reason of annealing by the heat treatment at a temperature range of from 350 to 800° C. is that it is preferred to close the holes, which are formed on the surfaces of the particles of acicular α-Fe₂O₃ obtained by the dehydration, by melting the surfaces of the particles by annealing to form smooth surface form.

Also, the acicular α-Fe₂O₃ particles obtained by the dehydration or annealing described above are dispersed in an aqueous solution to form a suspension, and after adjusting the pH thereof by adding thereto, for example, an Al compound and coating the surfaces of the α-Fe₂O₃ particles with the above-described addition compound, a filtration, water washing, drying, grinding, and further, if necessary, deairing, a press-dense treatment, etc., may be applied. As the Al compound, an aluminum salt such as aluminum acetate, aluminum sulfate, aluminum chloride, aluminum nitrate, etc., or an alkali alminate such as sodium alminate, etc., can be used. In this case, the addition amount of the Al compound is usually from 0.01 to 50% by weight as Al conversion to the α-Fe₂O₃ particle powder. Also, with the Al compound, by using an Si compound and also one or more kinds of the compounds of selected from P, Ti, Mn, Ni, Zn, Zr, Sn, and Sb, the above-described α-Fe₂O₃ particles can be coated. The addition amount of the compound, which is used together with the Al compound, is usually in the range of from 0.01 to 50% by weight to the α-Fe₂O₃ particle powder.

The production method of titanium dioxide is as follows. As these production methods of titanium dioxide, there are mainly a sulfuric acid method and a chlorine method. In the sulfuric acid method, the original ore of iluminite is digested with sulfuric acid to extract Ti, Fe, etc., as the sulfates. Iron sulfate is removed by crystallization-separation, after filtering purifying the remaining titanyl sulfate solution, a thermal hydrolysis is carried out to precipitate hydrate titanium oxide. After recovering the precipitates by filtration and washing, mixed impurities are removed by washing, and after adding thereto a particle size controlling agent, etc., the precipitates were burned at a temperature of from 80 to 1000° C. to provide crude titanium oxide. The rutile type and the anatase type can be selected by the kind of the nucleating agent added at the hydrolysis. By applying grinding, particle regulating, a surface treatment, etc., to the crude titanium oxide, desired titanium oxide is obtained. In the chlorine method, as the original ore, natural rutile or synthetic rutile is used. The ore is chlorinated in a high-temperature reduced state, Ti becomes TiCl₂ and Fe becomes FeCl₂, and the iron oxide, which becomes solid by cooling, is separated from liquid TiCl₄. After purifying crude TiCl₄ obtained by a rectification, a nucleating agent is added, and TiCl₄ is instantly reacted with oxygen at a temperature of at least 1000° C. to obtain crude titanium oxide. The finishing method of imparting a pigment like property to crude titanium oxide obtained by the oxidative decomposition process is same as in the sufuric acid method.

The surface treatment is carried out as follows. That is, after dry grinding the above-described titanium oxide material, water and a dispersing agent are added thereto, and by wet grinding and centrifugal separation, the crude particle classification is carried out. Thereafter, the fine particle slurry is transferred to a surface treatment bath, in which the surface coating with a metal hydroxide is carried out. First, a definite amount of an aqueous solution of the salt of Al, Si, Ti, Zr, Sb. Sn, Zn, etc., is added, and then by adding an acid or an alkali to neutralize the solution to coat the surfaces of the titanium oxide particles with the hydrate oxide formed. By-produced water-soluble salts are removed by decantation, filtration, and washing, finally, the pH of the slurry is controlled, solid components are separated by filtration and washed with pure water. The washed cake is dried by a spray dryer or a band dryer. Finally, the dried product is ground by a jet mill to provide a product. Also, not only by water system, bit also, the vapors of AlCl₃ and SiCl₄ are passed to the titanium oxide particles and thereafter, by introducing steam, the surface treatment can be applied.

About other production methods of the pigment, the description of G. D. Parfait and K. S. W. Sing “Characterization of Powder Surfaces”, Academic Press, 1976 can be referred to.

By incorporating carbon black in the lower layer, Rs can be lowered, which is a known effect, the light transmittance can be reduced, and also a desired micro Vickers hardness can be obtained.

The micro Vickers hardness of the lower layer is usually from 25 to 60 kg/mm² (245 to 588 MPa), and preferably from 30 to 50 kg/mm² (294 to 490 MPa), and the hardness is measured using a thin-film harness meter, HMA-400, manufactured by NEC Corporation and using a diamond-made triangular pyramid stylus having a sharpness of 80 degree and a tip radius of 1 μm at the tip of the indenter. The light transmittance is generally that the absorption of ultraviolet ray of a wavelength of about 900 nm is 3% or lower, and for example, in VHS, it is standardized that the absorption is 0.8% or lower. For the purpose, furnace for rubber, thermal for rubber, black for color, acetylene black, etc., can be used.

The specific surface of carbon black used for the lower layer is usually from 100 to 500 m²/g. and preferably from 150 to 400 m²/g, and the DBP oil absorption thereof is usually from 20 to 400 ml/100 g, and preferably from 30 to 200 ml/100 g. The particle size of carbon black is usually from 5 nm to 80 nm, preferably from 10 to 50 nm, and more preferably from 10 to 40 nm. Usually, it is preferred that the pH of carbon black is from 2 to 10, the water content is from 0.1 to 10%, and the tap density is from 0.1 to 1 g/ml.

Practical examples of carbon black used in the invention include BLACK PEARLS 2000, 1300, 1000, 900, 800, 880, and 700, manufactured by Cabot Corporation; #3050B, 3150B, 3250B, #3750B, #3950B, #950, #650, #970, #850 and MA-600; manufactured by Mitsubishi Chemical Corporation; CONDUCTEX SC. RAVEN 8800, 7000, 5750, 5250, 3500,2100, 2000, 1800, 1500, 1255, and 1250, manufactured by Columbia Carbon Corporation; Ketchen Black EC, manufactured by Akzo Co., etc. Carbon black used in the invention may be surface treated with a dispersing agent, or the surface thereof may be grafted with a resin, or a part of the surface may be graphitized. Also, before adding carbon black to the coating material, the carbon black may be previously dispersed with a binder. The carbon black can be used in the range of not exceeding 50% by weight to the above-described non-magnetic inorganic powder and in the range of not exceeding 40% of the total amount of the non-magnetic layer.

Carbon black, which can be used for the lower layer, can refer to, for example, “Carbon Black Handbook” edited by Carbon black Society of Japan. Also, according to purposes, an organic powder can be added to the lower layer. Examples of the organic powder, which can be used for the lower layer, include an acryl-styrene-base resin powder, a benzoguanamine resin powder, a melamine-base resin powder, and phthalocyanine-base pigment, but a polyolefin-base resin powder, a polyester-base resin powder, a polyamide-base resin powder, a polyimide-base powder, and a polyethylene fluoride resin powder can be also used.

As the production method thereof, the methods described in Japanese Patent Laid-Open Nos. 18564/1987 and 255827/1985 can be used.

The formation of an undercoat layer is carried out in general magnetic recording media, but the layer is formed for improving the adhesion of a support and a magnetic layer or a lower layer, and a solvent-soluble polyester is used. The thickness of the undercoat layer is generally 0.5 μm or thinner.

As the binder resin, the lubricant, the dispersing agent, additives, the solvent, the dispersing method, and the like for the lower layer, those for the magnetic layer can be applied. Particularly, in regard to the amount and the kind of the binder resin, and the addition amounts and the kinds of additives and the dispersing agent, the known techniques about the magnetic layer can be applied.

The thermoplastic resin, which can be used for the magnetic layer and the lower layer of the invention, has a glass transition temperature of from −100 to 150° C., a number average molecular weight of from 1,000 to 200,000, and preferably from 10,000 to 100,000, and the polymerization degree of from about 50 to 1,000. Examples of the thermoplastic resin include polymers or copolymers containing vinyl chloride, vinyl acetate, vinyl alcohol, maleic acid, acrylic acid, an acrylic acid ester, vinylidene chloride, acrylonitrile, methacrylic acid, a methacrylic acid ester, styrene, butadiene, ethylene, vinyl butyral, vinyl acetal, vinyl ether, etc., as the constituting unit; a polyurethane resin, and various kinds of rubber-base resins.

Also, the thermosetting resin or the reactive resin, which can be used in the invention, includes a phenol resin, an epoxy resin, a polyurethane setting type resin, a urea resin, a melamine resin, an alkyd resin, an acrylic reactive resin, s formaldehyde resin, silicone resin, an epoxy-polyamide resin, a mixture of a polyester resin and an isocyanate prepolymer, a mixture of polyester polyol and polyisocyanate, a mixture of polyurethane and polyisocyanate, etc. These resins are described in detail in “Plastic Handbook# published by Asakura Shoten. Also, a known electron ray-setting type resin can be used for the lower layer or the upper layer.

These examples and the production methods are described in detail in Japanese Patent Laid-Open No. 256219/1987.

The above-described resins can be used singly or as a combination thereof, but as the preferred examples, there are a combination of a polyurethane resin and at least one kind selected from a vinyl chloride resin, a vinyl chloride-vinyl acetate resin, a vinyl chloride-vinyl acetate-vinyl alcohol resin, and a vinyl chloride-vinyl acetate-maleic anhydride copolymer; and a combination of the combination with polyisocyanate.

As the structure of the polyurethane resin, the known structure such as polyester polyurethane, polyether polyurethane, polyether polyester polyurethane, polycarbonate polyurethane, polyester polycarbonate polyurethane, polycaprolactone polyurethane, polyolefin polyurethane, etc., can be used. Particularly, the polyurethane made of the short-chain diol having a cyclic structure and the long-chain diol containing an ether group described above is preferred.

About all the binders described above, for obtaining the more excellent dispersibility and durability, it is preferred to use the binder having introduced by a copolymerization or an addition reaction at least one polar group selected from —COOM, —SO₃M, —OSO₃M, —P═O(OM)₂, —O—P═O(OM)₂ (wherein, M described above shows a hydrogen atom or an alkali metal base), —OH, —NR₂, —N⁺R₃ (wherein, R shows a hydrocarbon group), an epoxy group, —SH, —CN, sulfobetaine, phosphobetaine, carboxybetaine, etc. The amount of such a polar group is from 10⁻¹ to 10⁻⁸ mol/g, and preferably from 10⁻² to 10⁻⁶ mol/g.

Practical examples of these binders which, are used in the invention, include VAGH, VMCH, VAGF, VAGD, VROH, VYES, VYNC, VMCC, XYHL, XYSG, PKHH, PKHJ, PKHC, and PKFE, manufactured by Union Carbide Corporation; MPR-TA, MPR-TA5, MPR-TAL, MPR-TSN, MPR-TMF, MPR-TS, MPR-TM, and MPR-TAO, manufactured by Nissin Kagaku Kogyo K.K.: 1000W, DX80, DX81, DX82, DX83, and 100FD, manufactured by DENKI KAGAKU KOGYO KABUSHIKI KAISHA; MR-104, MR-105, MR110, MR100, and 400X-110A; manufactured by ZEON CORPORATION; Nipporan N2301, N2302, and 2304, manufactured by NIPPON POLYURETHANE INDUSTRY CO., LTD., Pandex T-5105, T-R3080, and T-5201; Barnoc D-400, and D-210-80; and Crysbon 6109 and 7209; manufactured by DAINIPPON INK & CHEMICALS, INC.; Bylon UR8200, UR8300, RV530, and RV280; manufactured by TOYOBO CO., LTD., Daipheramine 4020, 5020, 5100, 5300, 9020, 9022, and 7020, manufactured by DAINICHISEIKA COLOR & CHEMICALS MFG. CO., LTD.; MX5004, manufactured by Mitsubishi Chemical Corporation; Sanorene SP-150 and TIM-3003, manufactured by SANYO CHEMICAL INDUSTRIES, LTD.; and Saran F310 and F210, manufactured by ASAHI KASEI CORPORATION. In these polymers, MR-104, MR110, UR-8200, UR8300, UR-9700, and the polyurethane, which is the reaction product of diol and an organic diisocyanate as the main raw materials, having a cyclic structure and an ether group are preferred.

In the invention, when a polyurethane resin is used, it is preferred that the breaking extension is from 100 to 2000%, the breaking stress is from 0.05 to 10 kg/mm² (0.45 to 98 MPa), and the yield point is from 0.05 to 10 kg/mm² (0.45 to 98 MPa).

The preferred examples of the polyisocyanate, which is used in the invention, include isocyanates such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, triphenylmethane triisocyanate, etc.; the reaction products of these isocyanates and polyalcohols, and the polyisocyanates formed by the condensation of the isocyanates. These isocyanates are commercially available as the trade names of Coronate L, Coronate HL, Coronate 2030, and Coronate 2031, Millionate MR and Millionate MTL, manufactured by NIPPON POLYURETHANE INDUSTRY CO., LTD.; Takenate D-102, Takenate D-110N, Takenate D-200, and Takenate D-202, manufactured by Takeda Chemical Industries, Ltd.; Desmodur L, Desmodur IL, Desmodur N, and Desmodur HL, manufactured by Sumitomo Bayer Co., etc. They can be used singly or a combination of two or more kinds for utilizing the difference of the setting reactions for the lower layer and the upper layer. The polyisocyanate is used in an amount of usually from 0 to 50% by weight, and preferably from 0 to 30% by weight to the whole binder resins of the upper layer, and in an amount of usually from 0 to 40% by weight, and preferably from 0 to 25% by weight to the whole binder resins of the lower layer.

When the magnetic recording medium of the invention is constructed by two or more layers, the amount of the binder resin; the amounts of the vinyl chloride-base resin, the polyurethane resin, the polyisocyanate, and other resins contained in the binder resin; and the molecular weight and the amount of the polar group of each resin forming the magnetic layer, and the physical characteristics of the resin described before can be, as a matter of course, changed in each layer according to the necessary, and also known techniques about multilayer magnetic layers can be applied.

The carbon black illustrated for the non-magnetic layer can be applied to the magnetic layer of the invention. Carbon black may be previously dispersed with a binder before adding to the magnetic coating material. These carbon blacks described above can be used singly or as a combination of them. In the case of using carbon black, it is preferred to use the carbon black in the amount of from 0.1 to 10% by weight, preferably from 0.1 to 3% by weight, and more preferably from 0.5 to 1.5% by weight to the amount of the ferromagnetic metal powder of the magnetic layer. Carbon black has he functions of the static prevention, the reduction of the friction coefficient, imparting the light shading property, the improvement of the film strength, etc., of the magnetic layer, and they differ according to the carbon black used. Accordingly, it is, as a matter of course possible, to change the kind, the amount, and the combination of the carbon blacks between the upper layer and the lower layer to properly use the carbon blacks according to the purposes based on the various characteristics such as the particle sizes, the oil absorptions, the electric conductivities, the pH, etc. The carbon black, which can be used for the magnetic layer of the invention, can refer to, for example, “Carbon Black Handbook” edited by the carbon black society of Japan.

As the abrasives, which can be used in the invention, known materials having the Mohs' hardness of at least 6, such as, α-alumina of the α ratio of at least 90%, β-alumina, silicon carbide, chromium oxide, cerium oxide, α-iron oxide, corundum, artificial diamond, silicon nitride, titanium carbide, titanium oxide, silicon dioxide, tin oxide, magnesium oxide, tungsten oxide, zirconium oxide, boron nitride are mainly used singly or as a combination of them. Also, the composite material of the abrasives with each other (an abrasive surface treated with other abrasive) may be used. As the case may be, the abrasive contains a compound or an element in addition to the main ingredient but when the content of the main ingredient is at least 90%, the effect of the abrasive is not changed. The mean particle size of the abrasives is preferably from 0.01 to 2 μm, but if necessary, the abrasive can be combined with other abrasive having different particle sizes, or even in a single abrasive, by widening the particle size distribution, the same effect can be imparted. Also, it is preferred that the tap density thereof is from 0.3 to 2 g/cc, the water content is from 0.1 to 5%, the pH is from 2 to 11, and the specific area is from 1 to 30 m²/g.

The shape of the abrasives used in the invention may be acicular, spherical, or a die-shape, but an abrasive having a corner at a part of the shape is preferred because of showing a high abrasive power. Practical examples of the abrasives, which can be used in the invention, include AKP-20, AKP-30, AKP-50, HIT-50, HIT-60, HIT-70, HIT-80, HIT-80G, and HIT-100, manufactured by Sumitomo Chemical Company, Ltd.; G5, G7, and S-1, manufactured by Nippon Chemical Industrial Co., Ltd.; TF-100 and TF-140, manufactured by Toda Kogyo K.K., etc. In regard to the abrasives used in the invention, the kind, the amount, and the combination can be, as a matter of course, changed from the lower layer and the upper layer to properly use according to the purposes. These abrasives may be added to the magnetic coating materials after being previously dispersing treated with a binder. It is preferred that the abrasives existing on the surface of the magnetic layer and the end surface of the magnetic layer of the magnetic recording medium of the invention are at least 5 particles/100 μm².

In the invention, the additives having a lubricating effect, an antistatic effect, a dispersing effect, a plasticizing effect, etc., are used. As such additives, for example, molybdenum disulfide, tungsten disulfide, graphite, boron nitride, fluorinated graphite, silicones having polar groups, a fatty acid-modified silicone, a fluorine-containing silicone, a fluorine-containing alcohol, polyolefin, polyglycols, an alkylphosphoric acid ester and the alkali metal salts thereof, an alkylsulfuric acid ester and the alkali metal salts thereof, a polyphenyl ether, a fluorine-containing alkylsulfuric acid ester and the alkali metal salts thereof, monobasic fatty acids having from 10 to 24 carbon atoms (which may contain an unsaturated bound or may be branched) and the metal salts thereof (Li, Na, K, Cu, etc.), monohydric, dihydric, trihydric, tetrahydric, pentahydric, and hexahydric alcohols having from 12 to 22 carbon atoms (which may contain an unsaturated bond or may be branched), alkoxy alcohols having from 12 to 22 carbon atoms (which may contain an unsaturated bond or may be branched); mono-fatty acid esters, di-fatty acid esters, or tri-fatty acid esters comprised of monobasic fatty acids having from 10 to 24 carbon atoms ((which may contain an unsaturated bond or may be branched) and one of monohydric, dihydric, trihydric, tetrahydric, pentahydric, and hexahydric alcohols having from 2 to 12 carbon atoms (which may contain an unsaturated bond or may be branched); the fatty acid ester of the monoalkyl ether of an alkylene oxide polymer; fatty acid amides having from 8 to 22 carbon atoms; aliphatic amines having from 8 to 22 carbon atoms, etc., can be used.

Practical examples thereof include lauric acid, myristic acid, palmitic acid, stearic acid, behenic acid, butyl stearate, oleic acid, linolic acid, linolenic acid, elaidic acid, octyl stearate, amyl stearate, isooctyl stearate, octyl myristate, butoxyethyl stearate, anhydrosorbitan monostearate, anhydrosorbitan distearate, anhydrosorbitan tristearate, oleyl alcohol, and lauryl alcohol. Also, nonionic surface active agents of alkylene oxide-base, glycerol-base, glycidol-base, alkylphenol ethylene oxide addition product, etc.; cationic surface active agents such as cyclic amines, ester amides, quaternary ammonium salts, hydantoin derivatives, heterocyclic compounds, phosphoniums, sulfoniums, etc.; anionic surface active agents having an acid group, such as a carboxylic acid, sulfonic acid, phosphoric acid, a sulfuric acid ester group, a phosphoric acid ester group, etc.; and amphoteric surface active agents such as amino acids, aminosulfonic acids, sulfuric acid or phosphoric acid esters of amino alcohol, alkylbetaine-base, etc., can be used. These surface active agents are described in detail in “Surface Active Agent Handbook” (published by Sangyo Tosho K.K.).

These lubricants, antistatic agents, etc., are not always 100% pure and may contain, in addition of the main component, impurities such as isomers, unreacted materials, side-reaction products, decomposed materials, oxides, etc. The content of these impurities are preferably not more than 30% by weight, and more preferably not more than 10% by weight.

About the lubricants and the surface active agents used in the invention, the kind and the amount thereof can be properly used for the lower layer and the magnetic layer. For example, it is considered that fatty acids each having a different melting point are used for the lower layer and the magnetic layer to control oozing them onto the surfaces, esters each having a boiling point are used for both the layers to restrain oozing them onto the surfaces, by controlling the amounts of the surface active agents for both the layers, the stability of the coating materials is improved, by increasing the addition amount of the lubricant to the lower layer, the lubricating effect is improved. As a matter of course, the proper uses of additives are not limited to the above-described examples.

All or a part of the additives used in the invention may be added to any step of the production of the magnetic coating material. For example, there are the case of mixing with the ferromagnetic powder before the kneading step, the case of adding in the kneading step of the ferromagnetic metal powder, the binder, and the solvent, the case of adding in the dispersing step, the case of adding after dispersing, the case of adding immediately before coating, etc. Also, if desired, after calendering or after slitting, the surface of the magnetic layer can be coated with a lubricant.

Examples of the commercially available products of the lubricants, which can be used in the invention, include NAA-102, NAA-415, NAA-312, NAA-160, NAA-180, NAA-174, NAA-176, NAA-222, NAA-34, NAA-35, NAA-171, NAA-122, NAA-142, NAA-160, and NAA-173K, and castor oil-cured fatty acids, NAA-42, NAA-44, Cation SA, Cation MA, Cation, AB, Cation BB, Naimeen L-201, Naimeen L-202, Naimeen S-202, Nonion E-208, Nonion P-208, Nonion S-207, Nonion K-204, Nonion NS-202, Nonion NB-210, Nonion HS-206, Nonion L-2, Nonion S-2, Nonion S-4, Nonion O-2, Nonion LP-20R, Nonion PP-40R, Nonion SP-60R, Nonion OP-80R, Nonion OP-85R, Nonion LT-221, Nonion ST-221, Nonion OT-221, Monogri MB, Nonion DS-60, Anon BF, Anon LG, butyl stearate, butyl laurate, and erucic acid, manufactured by NOF Corporation; oleic acid, manufactured by Kanto Kagaku K.K.; FAL-205 and FAL-123, manufactured by Takemoto Yushi K.K.; NJLUB, NJLUB IPM, and Sanso Seizer E4030, manufactured by New Japan Chemical Co., Ltd.; TA-3. KF-96, KF-96L, KF96H, KF410, KF420, KF965, KF54, KF50, KF56, KF907, KF393, KF-857, KF-860, KF-865, X-22-980, KF-101, KF-102, KF-103, X-22-3710, X-22-3715, KF-910, and KF-3935, manufactured by Shin-Etsu Chemical Co., Ltd.; Armide P, Armide C and Armoslip CP, manufactured by Lion Armor Corporation; Duomin TDO, manufactured by Lion Corporation; BA-41G, manufactured by THE NISSHIN OIL MILLS, LTD.; Prophan 2012E, Newpole PE61, Ionet MS-400, Ionet MO-200, Ionet DL-200, Ionet DS-300, Ionet DS-1000, and Ionet DO-200, manufactured by SANYO CHEMICAL INDUSTRIES, LTD., etc.

As the organic solvents, which are used in the invention, ketones such as acetone, methyl ethyl ketone, methyl isobutyl ketone, diisobutyl ketone, cyclohexanone, isophorone, tetrahydrofuran, etc.; alcohols such as methanol, ethanol, propanol, butanol, isobutyl alcohol, isopropyl alcohol, methylcyclohexanol, etc.; esters such as methyl acetate, butyl acetate, isobutyl acetate, isopropyl acetate, ethyl lactate, glycol acetate, etc.; glycol ether-base solvents such as glycol dimethyl ether, glycol monoethyl ether, dioxane, etc.; aromatic hydrocarbons such as benzene, toluene, xylene, cresol, chlorobenzene, etc.; chlorinated hydrocarbons such as methylene chloride, ethylene chloride, carbon tetrachloride, chloroform, ethylene chlorohydrin, dichlorobenzene, etc.; N,N-dimethylformamide, dimethylacetamide, hexane, etc., can be used at an optional ratio, These organic solvents are not always 100% pure and may contain impurities such as isomers, unreacted materials, side-reaction products, decomposition products, oxides, water, etc. The contents of these impurities are preferably not more than 30% by weight, and more preferably not more than 10% by weight. It is preferred that the kind of the organic solvent used in the invention is same for the magnetic layer and the lower layer. The addition about thereof may be changed between the magnetic layer and the lower layer. A solvent having a surface tension (cyclohexanone, dioxane, etc.) is used for the lower layer to increase the stability of coating, practically, it is important that the arithmetic average value of the solvent composition of the upper layer is not lower than the arithmetic average value of the solvent composition of the lower layer. For improving the dispersibility, it is preferred that the polarity of the solvent is strong to some extent, and it is preferred that the solvent composition contains at least 50% by weight a solvent having a dielectric constant of from 15 to 20. Also, the dissolution parameter is from 8 to 11.

The support of the magnetic recording medium of the invention is generally from 1 to 100 μm. but the thickness construction of the magnetic recording medium of the invention described above is particularly effective in the case of using a thin support having a thickness of from 1 to 8 μm. The total thickness of the magnetic layer and the lower layer is used in the range of from 1/100 to 2 times the thickness of the support. Also, to improve the adhesion between the support and the lower layer, it is preferred to form an adhesive layer.

The thickness of the adhesive layer is from 0.01 to 2 μm, and preferably from 0.02 to 0.5 μm. Also, a back coat layer may be formed at the opposite side of the support to the magnetic layer side. The thickness of the back coat layer is from 0.1 to 2 μm, and preferably from 0.3 to 1.0 μm. As the adhesive layer and the back coat layer, known materials can be used.

The support used in the invention has a micro Vickers hardness of at least 75 kg/mm² (735 MPa), and as the support, a known film subjected to biaxial stretching, such as polyethylene naphthalate, polyamide, polyamideimide, aromatic polyamide, polybenzoxydazole, etc., can be used. The support using an aromatic polyamide or a polyethylene naphthalate commercially available as “Aramid” manufactured by Toray Industries, Inc., and “Aramica” manufactured by ASAHI KASEI CORPORATION is particularly preferred.

The support may be previously subjected to a corona discharging treatment, a plasma treatment, an easily adhesion treatment, a heat treatment, a dust-removing treatment, etc. For attaining the objects of the invention, it is preferred to use a support having the centerline average surface roughness of the surface thereof for coating the magnetic layer of from 10 to 0.1 nm, preferably from 6 to 0.2 nm, and more preferably from 4 to 0.5 nm. Also, it is preferred that the support has not only the small center line average roughness but also there are no coarse projections of at least 1 μm. Also, the roughness form of the surface of the support is freely controlled by the size and the amount of the filler added to the support. As the examples of the filler, there are oxides and carbonates of Al, Ca, Si, Ti, etc., which may be crystalline or amorphous, and acrylic and melamine-base inorganic fine powders. Also, for obtaining the sunning durability together with the above-described effect, it is preferred that the roughness of the surface of the support onto which the back layer is formed is rougher than the roughness of the surface onto which the magnetic layer is formed. The centerline surface roughness of the surface of forming the back layer is preferably from 1 to 20 nm, and more preferably from 2 to 8 nm. In the case of changing the roughness between the magnetic layer coating surface and the back layer coating surface, a support of a dual structure may be used or the surface roughness may be changed by forming a coating layer.

The F-5 value of the tape-running direction of the support used in the invention is preferably from 10 to 50 kg/mm² (98 to 490 MPa) and the F-5 value of the width direction of the tape is preferably from 10 to 30 kg/mm² (98 to 294 MPa), and it is general that the F-5 value of the lengthwise direction of the tape is higher than the F-5 value of the width direction of the tape, but when it is particularly necessary to increase the strength of the width direction of the tape, it is excepted from the rule. Also, the heat shrinkage of the tape running direction and the width direction of the support at 100° C. for 30 minutes is preferably 3% or lower, and more preferably 1.5% or lower, and the heat shrinkage ratio at 80° C. for 30 minutes is preferably 1% or lower, and more preferably 0.5% or lower. Also, it is preferred that the breaking strength is from 5 to 100 kg/mm² (49 to 980 MPa) in both the directions, and the modulus of elasticity is preferably from 100 to 2,000 kg/mm² (0.98 to 19.6 GPa). Also, in the invention, the light transmittance at 900 nm is preferably not higher than 30%, and more preferably not higher than 3%.

The process of producing the magnetic coating material of the magnetic recording medium of the invention is comprised of at least a kneading step, a dispersing step, and, if necessary, a mixing step formed before and after these steps. Each step may be separated into two or more stages. The raw materials used in the invention, such as the ferromagnetic metal powder, the binder, carbon black, the abrasives, the antistatic agent, the lubricant, the solvents, etc., may be added before or during any step. Also, each raw material may be two or more separated steps. For example, the polyurethane resin may be separately added at the kneading step, the dispersing step, and a mixing step for viscosity control after dispersing. For attaining the objects of the invention, prior art production techniques can be, as a matter of course, used as the steps of a part but in the kneading step, it is preferred to use a kneading means having a strong kneading power, such as a continuous kneader, and pressure kneader, etc., since by using such a kneading means, the higher Br can be obtained. In the case of using the continuous kneader or the pressure kneader, the ferromagnetic metal powder and all the binders or a part of the bonders (at least 30% by weight of all the binders is preferred), or in the range of from 15 to 500 parts of the binders to 100 parts of the ferromagnetic powder are kneaded. Details of the kneading treatment are described in Japanese Patent Laid-Open Nos. 166338/1989 and 79274/1989. Also, in the case of preparing the coating liquids for the magnetic layer and the non-magnetic layer or the abrasive dispersion, it is desirable to use dispersion media having a high specific gravity, and zirconia beads are suitable.

In the invention, as the examples of the apparatus and method of simultaneously double coating for preparing the magnetic recording medium of a double layer structure, the following constructions can be proposed.

1. First, the coating layer of the lower layer is coated on a support by a gravure coating apparatus, a roll coating apparatus, a blade coating apparatus, an extrusion coating apparatus, etc., which is generally used for coating a magnetic coating material, and then while the coated layer of the lower layer is in a wet state, the coating layer of the upper layer is coated thereon by a support-press type extrusion coating apparatus disclosed in Japanese Patent Publication No. 46186/1989 or Japanese Patent Laid-Open Nos. 238179/1985 and 26572/1990.

2. The coating layers of the upper and lower layers are almost simultaneously coated on a support by one coating head having therein two coating liquid-passing slits as disclosed in Japanese Patent Laid-Open Nos. 88080/1988, 17971/1990, and 265672/1990.

3. The coating layers of the upper and lower layers are almost simultaneously coated on a support by an extrusion coating apparatus equipped with a back up roll disclosed in Japanese Patent Laid-Open No. 174965/1990.

In addition, for preventing lowering of the electromagnetic characteristics of the magnetic recording medium by the aggregation of the magnetic particles, it is desirable to impart shearing to the coating liquid in the inside of a coating head by the method disclosed in Japanese Patent Laid-Open No. 95174/1987 or 236968/1989.

Furthermore, it is preferred that the viscosity of the coating liquid satisfies the numeral range disclosed in Japanese Patent Laid-Open No. 8472/1991.

For obtaining the magnetic recording medium of the invention, it is preferred to carrying out a strong orientation. In the case of the magnetic recording tape, the magnetic recording medium is oriented in the lengthwise direction and in this case, it is preferred to use a solenoid of at least 100 mT, and preferably at least 300 mT together with a cobalt magnet of a magnetic field of at least 200 mT, preferably at least 400 mT, and more preferably 600 mT in same-pole opposing. It is preferred to form a proper drying step for previously drying before applying the orientation such that the orientated property after drying becomes highest. Also, in the case of a floppy disc, a random orientation is applied. In the orientation condition, after orienting to the lengthwise direction of the tape as the case of the magnetic tape, the tape is passed through the inside of an AC magnetic field generating apparatus of two magnetic field strengths of, for example, a magnetic field strength of 25 mT at a frequency of 50 Hz or a magnetic field strength of 12 mT at a frequency of 50 Hz, whereby the tape is subjected to a random orientation.

Also, it is preferred to form an adhesive layer made of a polymer as the main constituent before simultaneously double layer coating the non-magnetic layer and the magnetic layer or combine known means of increasing the adhesion by applying corona discharging, an ultraviolet irradiation, and an electron ray irradiation. Furthermore, as the rolls for the calender treatment, plastic rolls having a heat resistance, such as an epoxy resin, a polyimide resin, a polyamide resin, a polyimideamide resin, etc., or metal rolls are used. Also, the tape can be treated by metal rolls each other, plastic rolls each other, or a pair rolls of a metal roll and a plastic roll. The treatment temperature is preferably from 70 to 120° C., and more preferably from 80 to 100° C. The line pressure is preferably from 200 to at least 500 kg/cm, and more preferably from 300 to at least 400 kg/cm.

The friction coefficient of the magnetic layer surface and the opposite surface of the magnetic recording medium of the invention to SUS420J is preferably from 0.1 to 0.5, and more preferably from 0.2 to 0.3. The surface intrinsic resistance is from 10⁴ to 10¹² Ω/square, the elastic modulus at 0.5% elongation of the magnetic layer in both the running direction and the width direction is preferably from 100 to 2,000 kg/mm² (0.98 to 19.6 GPa), the breaking strength is preferably from 1 to 30 kg/mm² (9.8 to 294 MPa), the elastic modulus of the magnetic recording medium of the invention in both the running direction and the width direction is preferably from 100 to 1,500 kg/mm² (0.98 to 14.7 GPa), the residual elongation is preferably 0/5% or lower, and the heat shrinkage thereof at all temperatures of lower than 100° C. is preferably 1% or lower, more preferably 0.5% or lower, most preferably 0.1% or lower, although 0% is an ideal. The glass transition temperature of the magnetic layer (the maximum point of the loss elastic modulus of the kinematic viscoelasticity measured at 110 Hz) is preferably 30 to 150° C., and that of the lower layer is preferably from 0° C to 100° C. The loss elastic modulus is preferably in the range of from 1×10⁷ to 8×10⁸ Pa, and the loss tangent is preferably not larger than 0.2.

When the loss tangent is too large, a viscosity trouble is liable to occur. The amount of the residual solvent contained in the magnetic layer is preferably not more than 100 mg/m², and more preferably not more than 10 mg/m², and it is preferred that the residual solvent contained in the upper layer is less than the residual solvent contained in the upper layer.

The magnetic characteristics of the magnetic layer of the magnetic recording medium of the invention, such as Hc, SFD, Bm, and Br are, unless otherwise indicated, the values measured using a vibration sample magnetometer (VSM) in a magnetic layer surface direction at a magnetic field of 10 kOe [Oe={1/(4π)}kA/m]. In the case of the magnetic tape, in the tape running direction, Hc is as described above, and squareness ratio (SQ) is usually at least 0.85, and is preferably from 0.85 to 0.95. The squareness ratios in two directions vertical to the tape running direction, that is the two squareness ratios of the direction which is parallel to the tape surface and is vertical to the tape running direction and of the direction which is vertical to the tape surface are preferably not larger than 80% of the squareness ratio of the running direction. The remanence coercive force Hr is also preferably from 1800 to 30.000 Oe (≅144 to 240 kA/m). Hc and Hr in the perpendicular direction are preferably 1000 to 50,000 Oe (≅80 to 400 kA/m).

The root-mean-square roughness R_{RMS} of the magnetic layer obtained by the evaluation by an interatomic force microscope (AFM) is preferably in the range of from 2 to 15 nm.

The magnetic recording medium of the invention has the lower layer and the upper layer and it can be easily presumed that according to the purposes, the physical characteristics are changed between the lower layer and the upper layer (magnetic layer). For example, the elastic modulus of the magnetic layer is increased to improve the running durability and at the same time, the elastic modulus of the lower layer is lowered than that of the magnetic layer to improve the tough of the magnetic recording medium with a head, etc. Also, it is effective in the invention to change the tensilizing method of the support to improve touching with head, and a support, which is tensilized to the direction vertical to the lengthwise direction of the tape has, as the case may be, an improved head-touching.

### EXAMPLES

Then, “parts” described below show “parts by weight” and “%” shows “% by weight”.

[Preparation of polyurethane resin]

(Synthesis of polyurethane resin A)

In a vessel equipped with a reflux condenser and a stirrer and being previously replaced with nitrogen, HBpA, which is the diol of formula 1, BpA-POP700, which is the diol of formula 2, and other diols, PPG400 and DEIS were added to a 50:50 mixture of cyclohexanone and dimethylacetamide at mol ratios of HBpA:BpA-PPO700:PPG400:DEIS=24:14:10:2, and dissolved therein at 60° C. under a nitrogen stream. In this case, di-n-dibutyltin dilaurate may be added as a catalyst in an amount of 60 ppm to the total amount of the raw materials.

Then, MDI (4,4-diphenylmethane di-diisocyanate) was added to the solution in an amount of the equimolar amount to the total amounts of the diols and the mixture was reacted at 90° C. for 6 hours to obtain a polyurethane resin A of Mw of 45000 and Mn of 25000, having 4.0 nmol/g of an ether group, and having introduced 8×10⁻⁵ mol/g of an Na group.

In addition, the above abbreviations show the following materials.

HBpA: Hydrogenated bisphenol A (Rikabinol HB, manufactured by New Japan Chemical Co., Ltd.)

BpA-PPO700: Polypropylene oxide addition product of bisphenol A (molecular weight 700)

PPG400: Polypropylene glycol (molecular weight 400)

DEIS: Sodium salt of bis(2-hydroxyethyl) sulfoisophthalate.

Using the above-described ferromagnetic metal powder and the polyurethane resin A prepared as described above, the coating liquid of the upper layer (upper layer liquid) and the coating liquid of the lower layer (lower layer liquid) were prepared.

Coating Liquid Recipes

| [Upper layer coating solution] | | |
|---|---|---|
| Ferromagnetic metal powder | 100 | parts |
| Hc | 2390 | Oe (≅ 191 |
| | | kA/m) |
| σs | 153 | A · m²/kg |
| SFD | 0.94 | |
| Crystallite size | 160 | angstroms |
| Mean long axis length | 0.10 | μm |
| S_{BET} | 46 | m²/g |
| Polyurethane resin | 20 | parts |
| Phenylphosphonic acid (PPA) | 0.32 | mol/kg- |
| | | ferromagnetic |
| | | metal powder |
| Carbon black (mean particle size: 80 nm) | 1 | part |
| Alumina (mean particle size: 0.2 μm) | 5 | parts |
| Stearic acid | 0.5 | part |
| Butyl stearate | 1.2 | parts |
| Methyl ethyl ketone | 120 | parts |
| Cyclohexanone | 120 | parts |
| [Lower layer coating solution] | | |
| Non-ferromagnetic inorganic powder | 85 | parts |
| described in Table 1 below | | |
| Carbon black (mean particle size: 20 nm) | 15 | parts |
| Vinyl chloride resin (MR 104, manufactured | 10 | parts |
| by ZEON CORPORATION) | | |
| Polyurethane resin A | 4.5 | parts |
| Polyisocyanate (Coronate L, manufactured by | | |
| NIPPON POLYURETHANE INDUSTRY CO., | 4.5 | parts |
| LTD.) | | |
| Phenylphosphonic acid (PPA) | 0.19 | mol/kg |
| non-magnetic inorganic powder | | |
| Stearic acid | 0.5 | part |
| Butyl stearate | 1.2 | parts |
| Methyl ethyl ketone | 120 | parts |
| Cyclohexanone | 120 | parts |

### Examples 1 to 3, Comparative Examples 1 and 2

After kneading and dispersing the components of the upper layer coating solution and the lower layer coating solution described above, the dispersions were filtered using a filter having a mean hole diameter of 1 μm to prepare each coating solution.

The coating solution for the lower layer was coated on the surface of a polyethylene naphthalate support having a thickness of 5.2 μm and the centerline surface roughness of the coating surface of the magnetic layer of 0.001 μm using a reverse roll at a dry thickness of 1.2 μm, and immediately thereafter, the coating solution for the upper layer was simultaneously double-layer coated thereof at a dry thickness of 0.17 μm, while both the coated layers were in wet states, a orientation was carried out by a cobalt magnet having a magnetic force of 500 mT and a solenoid having a magnetic force of 400 mT followed by drying, the coated layers thus dried were subjected to a calender treatment by 7 stage calender constituted of metal rolls and epoxy resin rolls at a temperature of 100° C. and at a speed of 200 m/minute, and thereafter, a back layer having a thickness of 0.5 μm was coated. The coated support was slit to a wide of 6.35 mm to prepare a DVC video tape.

The characterizes of the recording magnetic media of the examples and the comparative examples obtained as described above were measured as the measurement methods described below and the results obtained are shown in Table 1 below.

[Measurement Methods]

Magnetic characteristics (Hc, Br): Using a vibration sample type magnetic flux meter (manufactured by Toci Kogyo K.K.), they were measured at Hm 10 KOe [Oe={1/(4π)}kA/m].

Average thickness d of magnetic layer: According to the above-described method.

The average thickness d after calendering was shown in Table 1.

Whole pore volumes: Using an all-automatic gas absorption amount measuring apparatus “AUTOSORB-1” manufactured by QUANTA CHROME CORPORATION, the volumes were measured by an N₂ adsorption method.

Ra: By a light interferometry using a digital optical profimeter (manufactured by WYKO Co.), the centerline average roughness Ra was measured at the condition of cut off 0.25 mm.

1/2 Tb Output: By reconstructing Comcorder DJ-1, manufactured by Matsushita Electric Industrial Co., Ltd., as Tb: BIT interval, the signal output of a frequency (21 MHz) of 1/2 Tb was measured.

The recording electric current was a deck-established value (recording wavelength λ=0.488 mm). 0 dB was REF for DVC. Tape MTR 1221. In addition, the value of at least −1 dB was used as the compatible standard.

1/90 Tb Output: By reconstructing Comcorder DJ-1, manufactured by Matsushita Electric Industrial Co., Ltd., as Tb: BIT interval, the signal output of a frequency (465 kHz) of 1/90 Tb was measured. The recording electric current was a deck-established value (recording wavelength λ=21.96 μm). 0 dB was REF for DVC. Tape MTR 1221. Usually at least −1.0 dB is practical, and is preferably at least 0.5 dB. In addition, the value of at least −1 dB was used as the compatible standard.

1/75 Tb-O/W (Overwrite): In addition, as the standard of a digital VCR (SD standard) for public use, the value of the 1/90 Tb overwrite is prescribed but if it is intended to directly measure it, it is required to greatly reconstruct the tracking method. Therefore, as the frequency, which does not influence on the tracking action, as the measurement method in place of the 1/90 Tb overwrite characteristics, the 1/75 Tb overwrite characteristics were evaluated. In addition, it has been already confirmed that the 1/90 Tb overwrite performance almost coincides with the 1/75 Tb overwrite performance. First, the signal of the frequency 1/75 Tb was recorded by the above-describe reconstructed machine of DJ-1. Thereafter, the 1/75 Tb signal is reproduced and the signal thereof is measured. Thereafter, after overwriting with a data signal, the residual signal of the 1/75 Tb signal is measured by a spectrum analyzer. The difference of the 1/75 Tb signal outputs before and after recording the data signal is defined to be the O/W erasing ratio. The same measurement was also carried out in regard to DVC ref TAPE MTR-1221 and the difference thereof is defined to be 1/75 Tb-O/W. In addition, the value of +1 dB or lower was used as the compatible standard.

TABLE 1

| | Non-magnetic Inorganic Powder of | | | | Upper Layer | | | | | | | |
|---|---|---|---|---|---|---|---|---|---|---|---|---|
| | Lower Layer | | | | Upper | | | | | Electromagnetic | | |
| | | Mean Long | Mean | Whole | Layer | | | | | Characteristics | | |
| | | Axis | Particle | Pore | Thickness | | | | | 1/2Tb | 1/90Tb | |
| | | Length | Size | Volumes | (d) | Hc | | Br | Ra | Output | Output | 1/75Tb-OW |
| Sample | Kind | (μm) | (μm) | mm³/g | (μm) | Oe | kA/m | mT | nm | dB | dB | dB |
| Ex.-1 | Acicular | 0.03 | — | 35 | 0.08 | 2280 | 182 | 665 | 2.6 | 1 | 0.5 | −0.8 |
| | Fe₂O₃ | | | | | | | | | | | |
| Ex.-2 | Acicular | 0.1 | — | 45 | 0.09 | 2310 | 185 | 600 | 2.5 | 0.6 | 0 | −0.5 |
| | Fe₂O₃ | | | | | | | | | | | |
| Ex.-3 | Spherical | — | 0.015 | 50 | 0.09 | 2370 | 190 | 560 | 2.7 | 0 | −0.5 | 0 |
| | TiO₂ | | | | | | | | | | | |
| C.Ex-1 | Acicular | 0.15 | — | 110 | 0.15 | 2400 | 192 | 486 | 3 | −1 | −0.8 | 6 |
| | Fe₂O₃ | | | | | | | | | | | |
| C.Ex-2 | Spherical | — | 0.035 | 105 | 0.16 | 2430 | 194 | 456 | 3.5 | −1.5 | −1.2 | 6 |
| | TiO₂ | | | | | | | | | | | |

Ex.: Example of the invention
C.Ex: Comparative Example

From the results of the above table, it can be seen that in the examples wherein the whole pore volumes are in the range of the invention, the output and OW characteristics are excellent as compared with the comparative examples wherein the while pore volumes are outside the range of the invention.

This application is based on Japanese patent application JP 2000-336246, filed Nov. 2, 2000, the entire content of which is hereby incorporated by reference, the same as if set forth at length.

What is claimed is:

1. A magnetic recording medium comprising a support and coated layers,
wherein the coated layers comprises: a lower layer containing a non-magnetic powder dispersed in a binder; and a magnetic layer containing a ferromagnetic powder dispersed in a binder, in the order, and
the coated layers has a whole pore volume of 10 to 50 mm³/g.

2. The magnetic recording medium according to claim 1, wherein the magnetic layer has a residual magnetic flux density Br of at least 500 mT.

3. The magnetic recording medium according to claim 1, wherein the magnetic layer has a coercive force Hc of 2100 to 3000 Oe, an SFD of 0.30 or lower, and an average thickness d satisfying the relationship: d≦λ/4, in which λ is a recording wavelength.

4. The magnetic recording medium according to claim 1, wherein the magnetic layer and the lower layer are formed by simultaneous double layer coating.

5. The magnetic recording medium according to claim 1, wherein the coated layers has a whole pore volume of 10 to 35 mm³/g.

6. The magnetic recording medium according to claim 1, wherein the magnetic layer has an average thickness d of 0.02 to 0.4 μm.

7. The magnetic recording medium according to claim 1, wherein the lower layer has an average thickness of 0.5 to 3 μm.

8. The magnetic recording medium according to claim 1, wherein the magnetic layer has a residual magnetic flux density Br of 500 to 800 mT.

9. The magnetic recording medium according to claim 1, wherein the binder resin in the magnetic layer contains 50 to 100% by weight of a polyurethane resin.

10. The magnetic recording medium according to claim 1, wherein the magnetic layer contains 70 to 100% by weight of a polyurethane resin based on the binder resin, and contains 5 to 18% by weight of the binder resin based on the ferromagnetic powder.

11. The magnetic recording medium according to claim 1, wherein the ferromagnetic powder is surface modified with an aromatic organic acid compound.

12. The magnetic recording medium according to claim 1, wherein the non-magnetic powder is a non-magnetic inorganic powder, and the lower layer contains 14 to 25 parts by weight of the binder resin based on 100 parts by weight of the total amount of the non-magnetic inorganic powder.
